(19) United States
(12) Patent Application Publication
(10) Pub. No.: US 2026/0184587 A1
(43) Pub. Date: Jul. 2, 2026

(54) METHOD OF CONVERTING CARBON DIOXIDE (CO2) IN FLUE GAS TO CALCIUM CARBONATE (CACO 3) USING CALCINED EGGSHELL

(71) Applicant: SÜLEYMAN DEMIREL ÜNIVERSITESI IDARI VE MALI ISLER DAIRE BASKANLIGI GENEL SEKRETERLIK, Isparta (TR)

(72) Inventors: Baris GÜREL, Isparta (TR); Karani KURTULUS, Isparta (TR); Sema YURDAKUL, Isparta (TR); Murat VAROL, Isparta (TR); Kamil EKINCI, Isparta (TR)

(21) Appl. No.: 19/130,960

(22) PCT Filed: Dec. 11, 2023
(86) PCT No.: PCT/TR2023/051510

§ 371 Date: May 19, 2025

(30) Foreign Application Priority Data
Dec. 30, 2022 (TR) 2022/021642

(51) Int. Cl. C01F 11/18; B01D 53/62; B01D 53/73

(52) U.S. Cl. CPC C01F 11/18; B01D 53/62; B01D 53/73; B01D 2253/112; B01D 2257/504; B01D 2258/0283

(57) ABSTRACT

The disclosure relates to a method and system (1) for capturing CO₂ by reacting CO₂ in the flue gas cooled to 600-700° C. after leaving the solid, liquid and gas combustion chamber with calcined eggshell powders in a tangential vortex formed in a cylindrical column (9) and forming CaCO₃ as a result of the reaction.

### FIELD OF THE INVENTION

The present disclosure relates to a method and system for converting carbon dioxide (CO₂) in flue gas into calcium carbonate (CaCO₃) by means of calcined eggshell, which enables the capture and conversion of CO₂ gas, which is the biggest cause of greenhouse gases in the flue gas resulting from the combustion of fossil fuels burned in thermal power plants and industrial boilers, into CaCO₃.

In particular, the present disclosure relates to a method and system for the reaction of calcined eggshell in a pyrolyzer with carbon dioxide in a cylindrical column in which carbon dioxide enters tangentially and is converted into calcium carbonate, and for the separation of CaCO₃ particles by flue gas in a cyclone.

### STATE OF THE ART

There are 4 different basic CO₂ capture technologies in the current state of the art. These are absorption, membrane, adsorption and chemical cycle technologies. Absorption applications with amine-based, ammonium and alkaline solutions and polymeric membrane technologies are used in commercial applications. CO₂ capture by adsorption and chemical cycling methods is still being studied at laboratory scale (Almoomori et al., 2017). The literature indicates that the cost of CO₂ separation can be as high as 75-85% of the overall CO₂ management cost (Herzog et al., 1997). The combustion of fossil fuels releases large amounts of CO₂ emissions into the atmosphere. Therefore, an inexpensive process is required to separate CO₂ from flue gas before it is compressed, cooled, liquefied, transported and finally separated. The use of high temperature sorbents such as CaO offers significant advantages over existing CO₂ separation techniques (adsorption, absorption, membrane separation, etc.) due to its high sorption capacity (5-10 times higher than that of adsorbents/absorbents).

In the current state of the art, in a process using a commercially available amine-based (MEA) process and calcined eggshell to remove CO₂ from flue gas, the sorbent/solvent cost ($/ton), CO₂ sequestration capacity (% by weight) and SO₂ management (ppm) were 1250/(60-120), 16/(40-70) and <10/(100-300) for MEA/MEA processes, respectively. Therefore, if this technology is adapted to existing power plants, it is obvious that significant energy and therefore cost savings can be achieved (Iyer et al., 2010). CaO can be used as a sorbent in a combined carbonator/fluidized bed. Thus, higher efficiency can be achieved. In this process, the CaO adsorbent undergoes a reversible reaction with CO₂ (Trzepizur, 2017) (Equation 1). According to the literature, calcined eggshells efficiently sequester SO₂ emissions in the 800-900° C. temperature range and CO₂ in the 600-700° C. temperature range (Iyer et al., 2010).

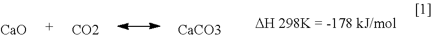

In short, carbonation is the treatment of calcium oxide with flue gas. While the process can generally take place in the temperature range of 600-850° C., carbonation is most suitable between 600-700° C. The resulting material is calcium carbonate. In the combustion chamber, CaO can sequester SO₂ more efficiently at temperatures of 800-900° C., while in the carbonator after the combustion chamber, CaO and CO₂ can be captured efficiently at 600-700° C. A separate fluidized bed reactor is required to sequester CO₂ in the carbonator. This process is difficult and generates an increase in investment cost. The need for a system that does not require a carbonator reactor has arisen due to the existing techniques that require a carbonator reactor and the difficulties and high cost inherent in the process itself.

Below are quotations from patent applications in the current technique and studies in the relevant technical field.

In the application numbered TR 2022/004278, titled as “Method of cleaning exhaust gas from CO₂ and/or SOx.” “Exhaust gas cleaning method comprising the processes of providing waste material rich in carbonatable Ca and/or Mg phases with d90≤1000 μm and a Rosin-Rammler slope (n) between 0.6 and 1.4, injecting the waste material into an exhaust gas stream containing CO₂ and/or SOx to react with CO₂ and/or SOx at a relative humidity between 50 and 100% by volume in dry waste material in an amount ranging from 5 to 30 kg/m3 and at a temperature between 4° and 130° C., partially withdrawing carbonatized and/or sulphurated waste material and purified exhaust gas and recycling of a portion of the partially carbonatized and sulphurated waste material while the remainder is discharged, as well as using of a waste material slurry for exhaust gas cleaning of CO₂ and/or SOx” is disclosed. This document describes a very different system than the system described in the present invention, which does not include a cylindrical column to increase the capture efficiency, a tangential feed area to mix the materials and capture carbon dioxide in the cyclone area.

TR 2018/18702 application numbered 2018/18702, titled “Conversion of Cogeneration Facilities into a Symbiosis Facility with Chicken Egg Production Facility and Elimination of CO₂ Emission and Other Wastes.” It is the minimization and elimination of carbon gas emissions which is the main cause of global warming, is the common problem of all countries of the world, resulting from combustion in cogeneration (thermal power plants, factories, metal production sector, oil refineries, etc.) facilities where combustion boilers are used and especially in places where egg poultry farming is carried out, and ensuring that it reacts with the energy released during the drying of chicken waste, especially in places where egg poultry farming is carried out and as a result converting the same into (NH4)2SO4 (Ammonium sulfate) fertilizer and CaSO4 (Calcium sulfate). The invention numbered TR 2018/18702 relates to the production of fertilizer by combining the residual gas generated during the drying of chicken waste and the residues generated during the operation of the cogeneration plant in a certain proportion, especially in egg-laying poultry farming areas. However, the document does not include the tangential feeding area and the system that increases the capture efficiency of carbon dioxide by means of a cylindrical carbon dioxide capture column. For these reasons, the invention provides a different and highly efficient method than the present technique.

In the document titled “Reactor with advanced architecture for electrochemical reaction of CO₂, CO and other chemical compounds.” with application number TR 2021/011476, it is stated that “a platform technology has been developed that utilizes a novel membrane electrode assembly comprising a cathode layer including a reduction catalyst and a first anion and cation conducting polymer, an anode layer including an oxidation catalyst and a cation conducting polymer, a membrane layer including a cation conducting polymer, the membrane layer is arranged between the cathode layer and the anode layer, and conductively connects the cathode layer and the anode layer in a CO₂ reduction reactor. The reactor can be used to synthesize a wide range of carbon-based compounds from carbon dioxide. “In the invention, a method and a system suitable for this method are provided to obtain calcium carbonate with high carbon dioxide capture efficiency, which does not require the use of carbonators that require the use of reactors and reactors.

In document numbered EP13382206.4 titled “CO2 capture system from a combustion stack gas using a CAO/CACO3 chemical cycle”, it is stated that “it relates to a system for the capture of CO2 from a combustion stack gas using a CaO/CaCO3 chemical cycle, where CO2 can be regenerated from large-scale combustion systems using CaO. CO2 is captured as a sorbent, where the CaO particles are carbonized at about 650° C. and then in contact with a flue gas. When supplied with sufficient heat for CaCO3 calcination at about 900° C., pure CO2 is released, wherein the system of this invention is characterized by a first direct heat exchange from a high temperature flue gas to a recirculation stream of calcined solids from the calcinator and/or a second direct heat exchange from a flue gas to carbonated solids from the calcinator, thus reducing the heat requirement for calcination.”

In the document numbered EP12185191.9, titled “Method of cleaning industrial waste gases containing CO2 by combustion in oxy-fuel boilers”, it is stated that “a gas processing plant for processing an industrial waste gas containing carbon dioxide includes an oxy-fuel boiler and pipes, these parts being arranged so as to participate in the combustion process occurring in the boiler for conveying the industrial waste gas to the oxy-fuel boiler and injecting the industrial waste gas into the oxy-fuel boiler and causing oxidation of at least part of the content of at least one oxidizable substance of the industrial waste gas. The gas processing plant also includes a gas cleaning system and a pipe for sending the carbon dioxide-rich flue gas produced in the boiler to the gas cleaning system to be cleaned there, resulting in at least partially cleaned carbon dioxide-rich flue gas.”

In document numbered EP09162003.9, titled “Method absorption medium and apparatus for co2 absorption from gas mixtures”, it is stated that “O2 is absorbed from a gas mixture by bringing the gas mixture into contact with an absorption medium, including water and 2,3-Dihydro-2,2,4,6-tetramethylpyridine. Absorption media according to the invention comprise water, 2,3-Dihydro-2,2,4,6-tetramethylpyridine and at least one organic solvent in homogeneous phase. The apparatus for separating CO2 from a gas mixture comprises an absorption unit, a desorption unit and an absorption medium according to the invention circulated.”

In document numbered EP08851343.7, titled “Method for inhibiting amine degradation during CO₂ capture from a gas stream.”, it is stated that The invention includes a method for inhibiting amine degradation during CO2 capture by amines from flue gas streams. In particular, the disclosure relates to a method of inhibiting O2- and/or SO2-induced degradation of amines during CO2 capture using sodium sulfite (Na2SO3), potassium sodium tartrate tetrahydrate (KNaC4H4O6 4H2O), ethylenediaminetetetraacetic acid (EDTA) or hydroxylamine (NH2OH) or similar compounds or mixtures thereof.

In document numbered EP07858641.9, titled “Clinker production method with controlled CO2 emissions.”, it is stated that “The invention relates to a method for producing clinker from raw material by carrying out the following: preheating of raw material with combustion gases; pre-calcination of raw material; and calcination of pre-calcined raw material in a rotary kiln, where the pre-calcination and calcination process in the rotary kiln produces combustion gases containing CO2, and where the combustion gases generated by pre-calcination are subjected to CO2 removal without mixing with the combustion gases generated by calcination in the rotary kiln.”

In document numbered EP07786251.4, titled “Method for reducing CO2-emission of a fossil-fired power plant facility”, the invention relates to a method for reducing CO2-emission of a fossil-fired power plant facility. According to the present invention, hydrocarbons are synthesized with hydrogen (H2) and carbon dioxide (CO2) contained in the flue gas of a power plant, if hydrogen is required here, it is obtained electrolytically with part of the electro energy of the power plant facility. Energy fuel is obtained by reducing CO2-emission. The invention also relates to a power plant which enables the implementation of a method comprising a synthesis reactor (18) in connection with a flue gas transfer system (9-12) of the power plant and, if necessary, units for the electrolytic recovery of hydrogen.

In document numbered EP06726286.5, titled “Combustion device producing hydrogen by reuse of captured CO2”, it is stated that “The invention relates to a combustion apparatus comprising a circulating fluidized bed reaction chamber generating smoke containing CO2 and vapor, a separator and heat recovery means comprising a section disposed in a dense fluidized bed. The innovative device is characterized by the fact that a section of the heat recovery device placed in the bed contains catalyst tubes through which a gas mixture flows. The gas mixture mentioned above comprises natural gas and/or naphtha or refinery gas or two or more of the aforementioned gases. The gas is regenerated and converted into synthesis gas containing hydrogen. Since the catalyst tubes are placed in a dense fluidized bed created by the ash from combustion, the catalyst can be heated evenly and the reaction to regenerate the natural gas mixture can be supported.”

Unlike each of the works in the present art, the invention comprises a system that allows eggshell powder particles and carbon dioxide to enter the cylindrical column tangentially and to increase the CO₂ sequestration efficiency by creating a vortex motion, in addition, the speed and flow rate of the flue gas eggshell mixture can be adjusted by placing a temperature resistant stainless valve at the outlet of the cylindrical column. By adjusting the valve, the flue gas velocity is changed and CO₂ capture efficiency is increased. With the cyclone area located after the valve, CaCO₃ formed by the reaction of CO₂ with calcined eggshell in the cyclone is sequestered. With said elements described in the invention and the method created, a method and system that saves energy without the need for a carbonator and the reactor required for the carbonator has been put forward.

In order to determine the state of the art, application documents TR2021/019720, TR2013/12161, EP12795790.0, EP10701545.5, EP11738632.6, TR2012/05813, EP12160549.7, EP09744615.7 and CN104959132A describing a method of preparation of a high temperature calcium-based CO2 adsorbent, EP06015077.8 on alumina adsorbents for the removal of water and carbon dioxide from a liquid, EP04700051.8 on combustion plant with CO2 recovery comprising an oxide reduction reactor fed with ground carbonaceous fuel and fluidized with a mixture of steam and carbon dioxide (CO2); EP12179675.9 relating to a method for reducing the amount of CO2 in a source containing carbon dioxide using a renewable ion exchange agent, EP12171700.3 relating to hydrogen production by CO2 capture, EP12722564.7 entitled Recirculation complex for improving fuel cell efficiency by Co2 capture and EP11718523.1 entitled CO2 purifier/separator using cyclic carbonator for controlled carbonate/bicarbonate production, document numbered EP09012501.4 describing the system including carbonator can be examined.

In the present art, in document US20060211571, entitled “High temperature CO2 Capture using eggshells”, the invention relates to CO2 capture using a calcined eggshell sorbent at the flue gas outlet. Document numbered US20060211571 outlines the capture of CO₂ in flue gas with eggshells. However, the present invention is very different from the invention numbered US20060211571 in that the following novelties and advantages have been obtained:
With the powdered eggshell feeding system, the powdered eggshell will be fed into the cylindrical CO₂ capture column.
Cylinder column geometry and tangential particle entry will be made to ensure that the calcined powdered eggshell particles react with CO₂ by vortex motion in the cylinder column geometry.
As the reaction takes place with vortex motion, the reaction time increases and as a result, the CO₂ sequestration efficiency of the system will be quite high.
By placing a valve at the outlet of the cylinder column before the cyclone, the speed of the flue gas eggshell powder mixture will be adjusted and the efficiency of CaCO₃ formation will increase.
CaCO₃ formed as a result of CO₂ capture in the cyclone located after the valve will be kept in the cyclone and useful CaCO₃ will be obtained by collecting from the bottom of the cyclone.

In the known state of the art, due to the solution of the problems described above and the inadequacies of existing techniques, innovation is required for the method of converting carbon dioxide (CO₂) in flue gas into calcium carbonate (CaCO₃) with calcined eggshell subject to our invention.

### BRIEF DESCRIPTION OF THE INVENTION

The present disclosure relates to a method of converting carbon dioxide (CO₂) in flue gas to calcium carbonate (CaCO₃) by means of calcined eggshell, which meets the above-mentioned requirements, eliminates all disadvantages and brings some additional advantages.

In the disclosure, without the need for a separate carbonator reactor, the geometry of the column between the combustion chamber outlet and the cyclone is rounded into a cylinder form and CO₂ is captured by feeding calcined eggshell powder tangentially to the column and creating a vortex. The CaCO₃ obtained is removed at the cyclone outlet. The CaCO₃ obtained is brought to a structure that can be easily transported to the place where CO₂ will be used. The method of the invention enables it to be calcined or used as CaCO₃ wherever needed.

Eggshell is calcined to obtain a CaO-dominated content and used to sequester CO₂. With the method of the invention and the system capable of implementing this method, CO₂ is captured in the flue gas with the calcined eggshell obtained by using only the calcinator instead of the carbonator and calcinator. The calcination process can be carried out alongside the incineration system and/or in storage facilities where CO₂ will be used or for fertilization in greenhouses.

The energy cost spent in the calcination process is recovered through the capture of CO₂, which can be offset by the gain from the use of CaCO₃ in a useful application such as soil enrichment or similar. This will make the system and the method of the present invention more efficient.

The method and the system of the present invention suitable for this method can be used to capture CO₂ from the flue gas generated in all industrial combustion systems with gas, liquid, and solid fuels. It can also be used to reduce CO₂ emissions from thermal power plants.

By the invention, the cylinder column geometry and tangential particle inlet are used to allow the reaction of calcined powdered eggshell particles with CO₂ by vortex motion in the cylinder column geometry.

By the present invention, the reaction time is increased while the reaction takes place with vortex motion and the CO₂ capture efficiency of the system is much higher than the existing one.

By the present invention, by placing a valve at the outlet of the cylinder column before the cyclone, the speed of the flue gas eggshell powder mixture is adjusted and the efficiency of CaCO₃ formation is increased.

In the disclosure, there is a structure that allows the CaCO₃ formed as a result of CO₂ capture in the cyclone located after the valve to be kept in the cyclone and collected from the bottom of the cyclone.

The disclosure results in an economical sorbent and a CO₂ capture system with low initial investment cost and operation.

The CaCO₃ obtained by calcining the eggshell and capturing the CO₂ in the flue gas is more useful than the CaCO₃ contained in the waste eggshell.

By the method of the present disclosure, the CaCO₃ in the raw eggshell is calcined and then CaCO₃ is captured in the system again to obtain a purified (purer) CaCO₃ by heating from microbes and parasitic effects.

The main objective of the invention is to develop a method for the capture of carbon dioxide in the flue gas cooled to 600-700° C. after leaving the solid, liquid and gas combustion chamber by reacting with calcined eggshell powders in the cylindrical column positioned here and to form CaCO₃ as a result of the reaction. Here, eggshell powder particles enter the cylindrical column tangentially and vortex motion is created to increase CO₂ capture efficiency. In addition, the velocity and flow rate of the flue gas eggshell mixture will be adjusted by placing a temperature resistant stainless valve at the outlet of the cylindrical column. By adjusting the valve, the flue gas velocity will be changed, and CO₂ capture efficiency will be increased. After the valve, a cyclone will be placed and CaCO₃ formed by the reaction of CO₂ with calcined eggshell will be captured in the cyclone. Thus, CO₂ gas, which is harmful to the atmosphere, will be captured and converted into CaCO₃, which has a high economic value. The CO₂ gas released from the calcined eggshell can vary depending on the intended use of calcination. In large power plants, CO₂ emitted by on-site calcination can be stored. In greenhouses, calcined CO₂ can be fertilized into the greenhouse and contribute to the growth of plants. As a result, CO₂ gas, which is harmful to the atmosphere in the flue gas, will be converted into CaCO₃, while the eggshell, which is a portable waste that needs to be disposed of, will be calcined at the place of use of CO₂ and a useful cycle will be created.

The structural and characteristic features of the present disclosure will be understood clearly by the following drawings and the detailed description made with reference to these drawings and therefore the evaluation shall be made by taking these figures and the detailed description into consideration.

### FIGURES CLARIFYING THE INVENTION

FIG. 1: A representative view of the carbon cycle in the “method of converting carbon dioxide (CO₂) in flue gas to calcium carbonate (CaCO₃) with calcined eggshell” of the present disclosure.

FIG. 2: A representative view of the “method of converting carbon dioxide (CO₂) in flue gas to calcium carbonate (CaCO₃) by calcined eggshell” of the present disclosure.

FIG. 3: A view representing the CO₂ capture and powdered eggshell feeding system (3) of the “method for converting carbon dioxide (CO₂) in flue gas to calcium carbonate (CaCO₃) with calcined eggshell” of the present disclosure.

FIG. 4: Representative diagrams of the process steps of the “method of converting carbon dioxide (CO2) in flue gas to calcium carbonate (CaCO3) with calcined eggshell” of the present disclosure.

### DESCRIPTION OF THE PROCESS STEPS

101. Calcining the eggshell
102. Transferring the calcined eggshell to the cylindrical column (9) via the feeding system (3)
103. Cooling the carbon dioxide (CO₂) at the outlet of the combustion chamber (7)
104. Tangential feeding of carbon dioxide into the cylindrical column (9)
105. Forming calcium carbonate (CaCO3) by the reaction of carbon dioxide with calcined eggshell fed tangentially in a cylindrical column (9),
106. Transferring carbon dioxide and calcined eggshell powder to the cyclone area (11) by adjusting the mixing speed with the valve (10),
107. Separating flue gas and calcium carbonate (CaCO₃) particles in the cyclone and transferring calcium carbonate (CaCO₃) under the cyclone area (11)

### DESCRIPTION OF THE ELEMENT REFERENCES

1. System
2. Pyrolizer
3. Feeding system
4. Feeding chamber
5. Centrifugal fan
6. Pipeline
7. Combustion chamber
8. Tangential feeding area
9. Cylindrical column
10. Valve
11. Cyclone area

### DETAILED DESCRIPTION OF THE INVENTION

In this detailed description, the preferred embodiments of calcined eggshell and flue gas carbon dioxide (CO₂) to calcium carbonate (CaCO₃) are described only for a better understanding of the subject and without any limiting effect.

The present disclosure is a method and system (1) for capturing CO₂ gas, which is the biggest cause of greenhouse gases in the flue gas resulting from the combustion of fossil fuels burned in thermal power plants and industrial boilers, and converting the same into CaCO₃ (1), characterized in that, it comprises the following;
At least one cylindrical column (9) with a cylindrical structure to increase CO₂ capture efficiency,
At least one cyclone area (11) to separate the CaCO₃ obtained as a result of the reactions in the cylindrical column (9) from the flue gas,
At least one feeding system (3) to feed the calcined eggshell into the cylindrical column (9), comprising at least one feeding chamber (4) with powdered eggshell, at least one conveying pipeline (6) for transferring the calcined powdered eggshells to the cylindrical column (9) and at least one centrifugal fan (5) conveying the calcined eggshells in the feeding chamber (4) to the pipeline (6) at a certain pressure,
At least one tangential feeding area (8) having a curved surface area which allows the calcined powdered eggshell particles to enter the cylindrical column (9) tangentially to capture CO₂ and
At least one valve (10), which is in the cylindrical column (9) for CO₂ capture to regulate the inlet flow rate of flue gas and calcined eggshell into the cyclone area (11) and its velocity in the column, is temperature resistant preferably made of stainless material at the outlet of the cylindrical column (9),
At least one combustion chamber (7) in which the temperature of CO₂ gases in the flue gas is reduced to 600-700° C. at the outlet
At least one pyrolyzer (2) that allows the eggshell to be calcined by calcination.

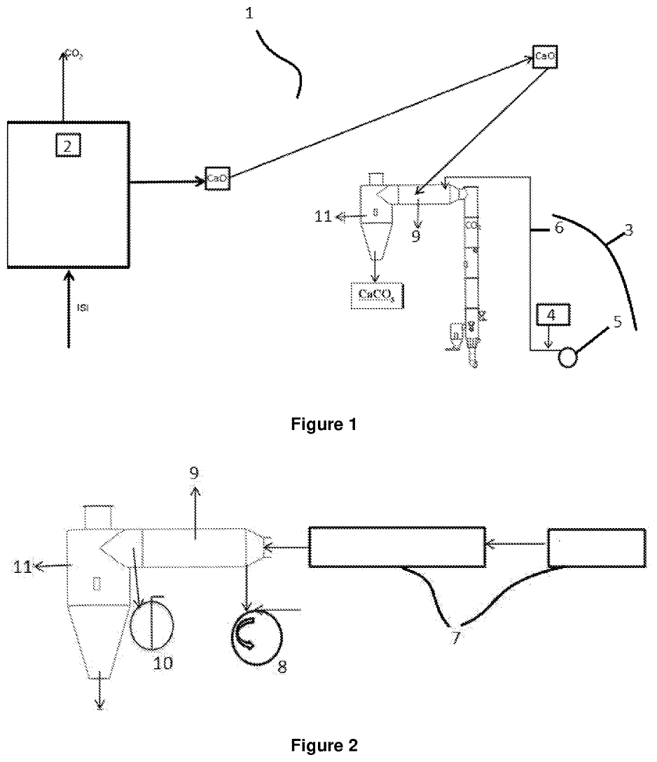

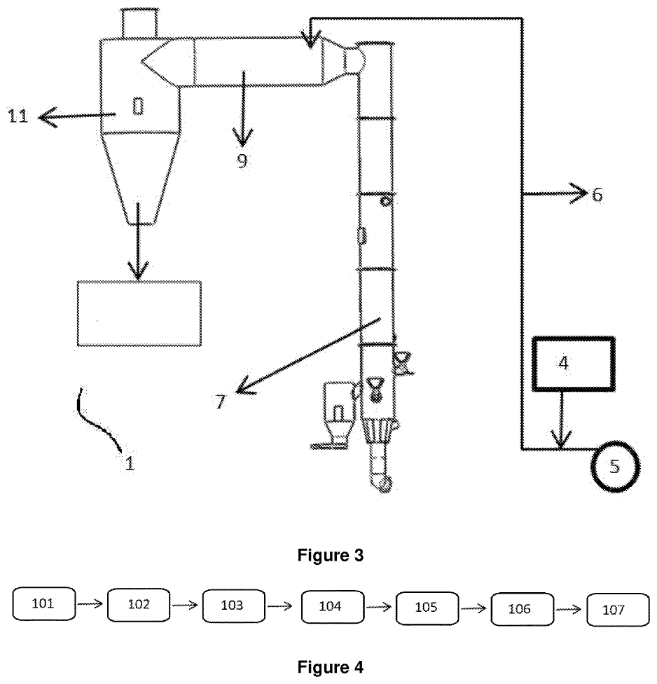

The carbon cycle in FIG. 1 and the process step diagrams are shown in FIG. 4. According to the order in the carbon cycle in the invention, the following processes take place.

A method for capturing CO₂ gas, which is the biggest cause of greenhouse gases in the flue gas resulting from the combustion of fossil fuels burned in thermal power plants and industrial boilers, and converting the same into CaCO₃, characterized in that, it comprises the following process steps;
Calcining the eggshell (101),
Transferring the calcined eggshell to the cylindrical column (9) via the feeding system (3) (102),
Cooling of carbon dioxide (CO2) from the flue gas at the outlet of the combustion chamber (7) (103),
Tangential feeding of carbon dioxide into the cylindrical column (9) (104),
Forming calcium carbonate (CaCO3) by the reaction of carbon dioxide with calcined eggshell fed tangentially in a cylindrical column (9) (105),
Transferring carbon dioxide and calcined eggshell powder to the cyclone area (11) by adjusting the mixing speed with the valve (10) (106),
Separating flue gas and calcium carbonate (CaCO₃) particles in the cyclone and transferring calcium carbonate (CaCO₃) under the cyclone area (11) (107).

In the step of calcining the eggshell (101), the eggshell is calcined (101) by applying calcination process in the pyrolyzer (2). The CO₂ gas produced during the eggshell calcination process can be used for CO₂ storage or fertilization in greenhouses. In this way, the CO₂ gas generated in the calcination process is utilized in areas where it is suitable for use. The calcined eggshell powder obtained from calcination is used in the cylindrical column (9) to capture CO₂ after the combustion chamber (7). CaCO₃ is formed in the cylindrical column (9) that captures CO₂ and then CaCO₃ particles are obtained under the cyclone by separating CaCO₃ and flue gas in the cyclone. In this way, the carbon cycle is completed.

In the process of capturing CO₂ and obtaining CaCO₃, with the method of the present invention, CO₂ in the flue gas will be captured in the cylindrical column (9) after the flue gas temperature is reduced to 600-700° C. at the outlet of the combustion chamber (7) with calcined eggshell without the need for an additional reactor, i.e., carbonator unit and the energy consumption required for this unit. The process of reducing the flue gas temperature to 600-700° C. is comprised by the process step of cooling the carbon dioxide (CO₂) exiting the flue gas at the outlet of the combustion chamber (7) (103).

In the process step of the forming calcium carbonate (CaCO₃) by reacting the calcined egg shell fed tangentially in the cylindrical column (9) and the carbon dioxide in the flue gas (105) comprises the process of capturing the carbon dioxide and reacting of the same by entering the geometry of the cylinder column (9) and tangential particles with the vortex movement of calcined eggshell particles with CO₂ in the geometry of cylinder column (9), and forming CaCO₃ are included.

The step of separating CaCO₃ particles and flue gas in the said cyclone and transferring the CaCO₃ particles to the bottom of the cyclone area (11) (107); it is the process of obtaining CaCO₃ particles under cyclone by keeping them in the cyclone area (11) as a result of the process step (105) which the CO₂ reacting with the calcined eggshell is transformed into CaCO₃.

Novelty-adding parts and steps in the method of converting CO2 in flue gas to CaCO₃ with calcined eggshell subject to our invention are as follows: Cylindrical column with cylindrical structure that increases CO₂ capture efficiency (9), cyclone area for the sequestering of the resulting CaCO₃ (11), feeding system (3) for feeding the calcined eggshell into the cylindrical column (9), tangential feeding area (8) to ensure a tangential, curved entry of particles into the cylindrical column (9) used for CO₂ sequestration of calcined powdered eggshell particles and a valve (10) in the cylindrical column (9) that provides CO₂ capture, to adjust the flow rate of flue gas and calcined eggshell entering the cyclone and the speed in the column.

In the disclosure, with the tangential feeding area (8) and the cylindrical column (9), the reaction time increases while the reaction takes place with vortex motion and as a result, the CO₂ sequestration efficiency is increased.

Calcined powdered eggshell feeding system (4) includes powdered eggshell feeding chamber (10), powder conveying pipeline (6) and centrifugal fan (12).

1. A system (1) for capturing CO₂ gas, which is the biggest cause of greenhouse gases in the flue gas resulting from the combustion of fossil fuels burned in thermal power plants and industrial boilers, and converting it into CaCO3 characterized by comprising;
At least one cylindrical column (9) that is cylindrical structure, to increase CO₂ capture efficiency,
At least one cyclone area (11) to keep separate the CaCO₃ obtained as a result of the reactions in the cylindrical column (9) from the flue gas,
At least one feeding system (3) to feed the calcined eggshell to the cylindrical column (9),
At least one tangential feeding area (8), which allows the calcined powdered eggshell particles to enter the cylindrical column (9) to capture CO₂.

2. The system (1) according to claim 1 characterized by comprising; at least one pyrolyzer (2) that allows the eggshell to be calcined by calcination.

3. The system (1) according to claim 1 characterized by comprising; a tangential feeding area (8) and a cylindrical column (9) which increase the reaction time while the reaction takes place by vortex motion and consequently the CO₂ capture efficiency of the system.

4. The system (1) according to claim 1 characterized by comprising; at least one combustion chamber (7) in which the temperature of CO₂ gases in the flue gas is reduced to 600-700° C. at the outlet.

5. The system (1) according to claim 1 characterized by comprising; at least one valve (10) provide to adjust the inlet flow rate and the velocity in the column of the flue gas and the calcined eggshell into the cyclone area (11) at the cylindrical column (9) that provide to capture of CO₂.

6. The system (1) according to claim 1 characterized in that; at least one valve (10) made of temperature resistant, stainless material at the outlet of the cylindrical column (9).

7. The system (1) according to claim 1 characterized by comprising; at least one feeding system (3) that comprises at least one feeding chamber (4) containing powdered eggshell.

8. The system (1) according to claim 1, characterized by comprising; at least one feeding system (3) that comprises at least one conveying pipeline (6) for conveying the calcined powdered eggshells to the cylindrical column (9).

9. The system (1) according to claim 1, characterized by comprising; at least one feeding system (3) that comprises at least one centrifugal fan (5) which transmits the calcined eggshells in the feeding chamber (4) at a certain pressure to the pipeline (6).

10. The system (1) according to claim 1, characterized by comprising; at least one tangential feeding area (8) having a curved surface area which allows the calcined powdered eggshell particles to enter the cylindrical column (9) tangentially to capture CO₂.

11. A method for capturing CO₂ gas, which is the biggest cause of greenhouse gases in the flue gas resulting from the combustion of fossil fuels burned in thermal power plants and industrial boilers, and converting it into CaCO3 characterized by comprising; the process steps of;
Calcining the eggshell (101),
Tangential feeding of carbon dioxide to a cylindrical column (9) (104),
Forming calcium carbonate (CaCO3) by the reaction of carbon dioxide with calcined eggshell fed tangentially in the cylindrical column (9) (105),
Transferring carbon dioxide and calcined eggshell powder to the cyclone area (11) by adjusting the mixing speed by a valve (10) (106),
Separating flue gas and calcium carbonate (CaCO₃) particles in the cyclone and transferring calcium carbonate (CaCO₃) under the cyclone area (11) (107).

12. The method according to claim 11 characterized by comprising; the process step of transferring the calcined eggshell to the cylindrical column (9) via the feeding system (3) (102).

13. The method according to claim 11 characterized by comprising; the process step of cooling the carbon dioxide (CO₂) from the flue gas at the outlet of the combustion chamber (7) (103).

14. The method according to claim 11 characterized by comprising; the process step of reducing the flue gas temperature to 600-700° C. in the process step of cooling the carbon dioxide (CO2) exiting the flue gas at the outlet of the combustion chamber (7) (103).

15. The method according to claim 11 characterized by comprising; the process step of providing the geometry of the cylindrical column (9) and the process of reacting the calcined powdered eggshell particles with CO₂ by capturing carbon dioxide with the vortex movement within the geometry of the cylinder column (9) and ensuring the formation of CaCO₃ by entering tangential particles in the process step of forming calcium carbonate (CaCO₃) by the reaction of calcined egg shell fed tangentially in the cylindrical column (9) and carbon dioxide (105).
